(19) United States
(12) Patent Application Publication
(10) Pub. No.: US 2025/0368379 A1
(43) Pub. Date: Dec. 4, 2025

(54) Electronics Tray And Cart System

(71) Applicant: InterMetro Industries Corporation, Wilkes-Barre, PA (US)

(72) Inventors: Carey Alan ROBERTS, Shavertown, PA (US); Matthew GABRIEL, Wilkes-Barre, PA (US)

(73) Assignee: InterMetro Industries Corporation, Wilkes-Barre, PA (US)

(21) Appl. No.: 19/175,171

(22) Filed: Apr. 10, 2025

Related U.S. Application Data
(60) Provisional application No. 63/652,415, filed on May 28, 2024.
(60) Provisional application No. 63/654,400, filed on May 31, 2024.

(51) Int. Cl. B65D 1/34; B65D 21/02; B65D 25/20

(52) U.S. Cl. CPC B65D 1/34; B65D 21/0212; B65D 21/0233; B65D 25/205

(57) ABSTRACT

A work tray is disclosed that incorporates features enabling multiple trays to both nest with one another and stack upon one another. When not in use, empty trays can be stored or transported in a compact and efficient arrangement requiring minimal space. When in use in a manufacturing environment (e.g., at a workstation or in a process queue) and while containing workpieces, the trays can be vertically stacked on top of one another for easy and efficient access to a technician or operator. The work tray further includes a progress indicator and marking regions that provide indicia of the tray and its contents to support an efficient workflow for the devices and components contained in the trays.

### CROSS-REFERENCE TO RELATED APPLICATION

This application claims the benefit of U.S. Provisional Application No. 63/654,400, filed on May 31, 2024 and U.S. Provisional Application No. 63/652,415, filed May 28, 2024. The entire disclosures of the above applications are incorporated herein by reference.

### FIELD

The present disclosure relates to trays and cart systems used during the manufacture, transport and storage of workpieces, such as for electronic devices and components, like printed circuit boards.

### BACKGROUND

This section provides background information related to the present disclosure which is not necessarily prior art.

Trays used during the manufacture, assembly, transport and/or storage of electronic devices and components that minimize the effects presented by electrostatic discharge (ESD trays) are known. ESD trays are used throughout a manufacturing process workflow for a variety of assembly, storage, staging and transport functions.

ESD trays are made from conductive materials that provide a controlled environment for preventing the accumulation and discharge of static electricity.

ESD trays help protect sensitive electronic devices and components throughout manufacturing, handling and storage from electrostatic discharge which can be detrimental to electronic devices and components, such as printed circuit boards (PCB) and the like, which are sensitive to even minor electrostatic discharges.

ESD trays can be used with specialty racks, carts or other storage and/or transport systems with the same conductive electrical properties as the ESD tray so as to circumvent damage to the electronic devices and components by conducting electrical static potential away from the devices to ground.

ESD trays can incorporate a nesting feature that minimizes the space needed for storing the trays when they are not in use or in bulk storage. Alternatively, other ESD trays can have a stacking feature that enables multiple trays to be stacked at a workstation in a single footprint that improves workflow ergonomics for a technician/operator. Conventional ESD tray solutions, however, incorporate only one or the other of a stacking feature or a nesting feature and not both.

Moreover, in the many manufacturing environments where ESD trays are employed, it is common that the ESD trays lack indicia regarding the state or condition of the devices and components in the tray. For example, whether a manufacturing process or step has been completed. To address this shortcoming, unreliable, ad hoc solutions are often utilized.

### SUMMARY

This section provides a general summary of the disclosure and is not a comprehensive disclosure of its full scope or all of its features.

The present disclosure relates to work trays for containing workpieces throughout a manufacturing process workflow for a variety of assembly, storage, staging and transport functions.

On one aspect of the disclosure, an ESD tray is disclosed. The ESD tray of the present disclosure includes features enabling its efficient use, transport and storage and which promote efficiencies in manufacturing processes and workflows.

The ESD tray of the present disclosure incorporates features enabling multiple trays to both nest with one another and stack upon one another. When not in use, empty trays can be stored or transported in a compact and efficient arrangement requiring minimal space. When in use in a manufacturing environment (e.g., at a workstation or in a process queue) and while containing workpieces, the trays can be vertically stacked on top of one another for easy and efficient access to a technician or operator.

In another aspect of the disclosure, the ESD trays include a plurality of protrusions, ribs, bosses, projections, guides, grooves, recesses, slots or like structure in the sidewalls of the trays. The protrusions of vertically adjacent trays can align with or oppose one another depending on the orientation of the trays. For example, a first protrusion in a first sidewall of the tray and a second protrusion in an opposed second sidewall of the tray can be diametrically opposed to one another or asymmetrical.

In a first orientation of two adjacent trays the trays are operable to nest with one another and in a second orientation of the two adjacent trays the trays are operable to stack upon one another. The first orientation and the second orientation can be offset about a central axis of the trays by 180 degrees.

The ESD tray of the present disclosure further includes a progress indicator that supports a manufacturing process workflow for the devices and components contained in the trays.

The progress indicator provides indicia of whether a job or task has been completed and whether the tray and the devices and components contained therein are ready for transport to a subsequent operation or storage. In this regard, the tray integrates a multi-position indicator (e.g., slider) into a lip or edge of the tray. As the tray and the workpieces contained therein process through a workflow, the indicator can be positioned by a technician or operator to signal a condition of the tray and workpieces. The progress indicator provides a reliable, visual que that allows the state or condition of trays and workpieces to be easily recognized and understood to promote efficient workflow and reduce uncertainty.

Further, the ESD tray of the present disclosure provides multiple locations for identifying the contents of the tray using standard printable labels or user-generated indicia.

The ESD tray of the present disclosure also includes dedicated handles for safe handling of the tray and components therein.

Although the present disclosure particularly describes the features and functions of a work tray in the context of an ESD tray, it should be recognized that these same features and functions can be applied to any of a variety of trays for containing workpieces throughout a manufacturing process workflow.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 shows a top-front-left perspective view of a work tray, such as an ESD tray, of the present disclosure;

FIG. 2 shows a left side view of the ESD tray of FIG. 1;

FIG. 3 shows a top view of the ESD tray of FIG. 1;

FIG. 4 shows an enlarged detail view of a portion of FIG. 3 indicated at 4;

FIG. 5 shows an enlarged detail view of a portion of FIG. 3 indicated at 5;

FIG. 6. shows an enlarged detail view of a portion of FIG. 1 indicated at 6;

FIG. 7. shows an enlarged detail view of a portion of FIG. 1 indicated at 7;

FIG. 8. shows an enlarged detail view of a portion of FIG. 1 indicated at 8;

FIG. 9 shows a top-front-left perspective view of multiple work trays, such as multiple ESD trays, of the present disclosure in a stacked arrangement;

FIG. 10 shows a top-front-left view of multiple ESD trays of the present disclosure in a nested arrangement;

FIG. 11 shows a front view of multiple ESD trays of the present disclosure in a stacked arrangement;

FIG. 12 shows a front view of multiple ESD trays of the present disclosure in a nested arrangement;

FIG. 13 shows a front view of the ESD tray of FIG. 1 and including a progress indicator in a first position;

FIG. 14 shows an enlarged detail view of a portion of FIG. 13 indicated at 14; and

FIG. 15 shows an embodiment of an exemplary cart system of the present disclosure.

Corresponding reference numerals indicate corresponding parts throughout the several views of the drawings.

### DETAILED DESCRIPTION

Example embodiments will now be described more fully with reference to the accompanying drawings.

The present disclosure provides a work tray for containing workpieces throughout a manufacturing process workflow for a variety of assembly, storage, staging and transport functions. More particularly, the present disclosure describes a work tray, such as an ESD tray 10, that includes features enabling its efficient use, transport and storage and which promote efficiencies in manufacturing processes and workflows.

An ESD tray 10 of a preferred embodiment of the present disclosure is shown in the figures. The ESD tray 10 allows multiple trays to both stack upon one another and nest with one another. When in use in a manufacturing environment (e.g., at a workstation or in a process queue) and while containing workpieces, the trays can be vertically stacked on top of one another for easy and efficient access by a technician or operator. When not in use, empty trays can be stored or transported in a compact and efficient arrangement requiring minimal space.

The tray 10 can include a generally flat base or bottom wall 12 and a plurality of peripheral sidewalls 14, 16, 18, 20 extending upwardly from the bottom wall 12 and about the perimeter of the bottom wall 12. Together the base 12 and the sidewalls 14, 16, 18, 20 form an inner compartment or receptacle 22 for the tray 10 that can house or contain workpieces (not shown). The bottom wall 12 provides a worksurface or storage area supporting the workpieces in the compartment 22 of the tray 10.

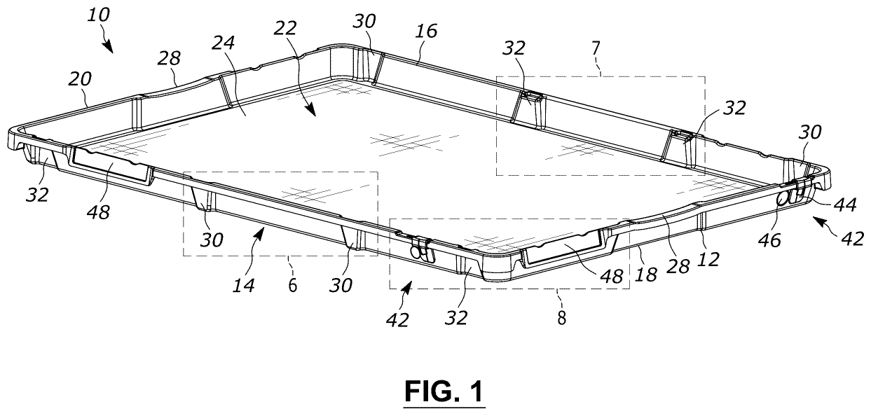

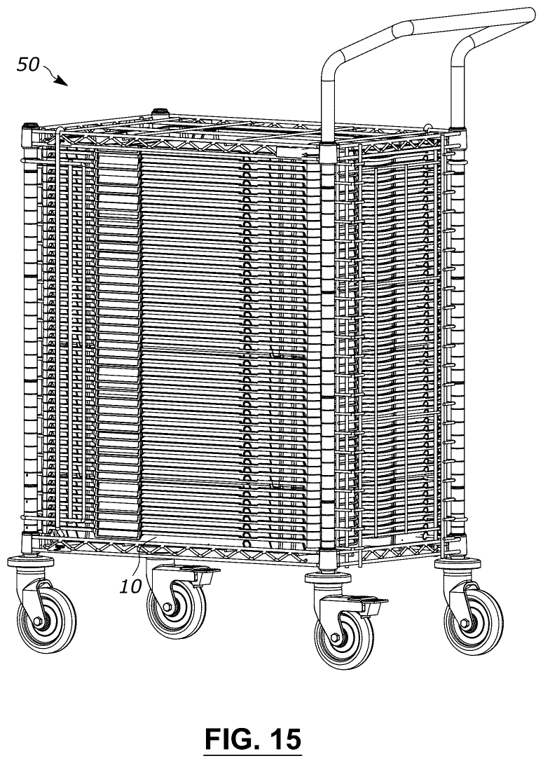

Referring to FIGS. 1-3, the tray 10 is generally polygonal-shaped and is preferably rectangular. The tray 10 can be dimensioned to fit into transport or storage racks (see, e.g., FIG. 15). For example, a tray 10 can be about 18 inches wide by about 24 inches long by about 1 inch or more high. Of course, many other sizes of the ESD tray of the present disclosure are possible. A rectangular shape of the ESD tray may be advantageous so the tray conforms with other readily available, commercial ESD trays. As such, the ESD tray of the present disclosure may be adapted for use with known apparatus configured to accommodate known commercial ESD trays.

The ESD tray 10 of the present disclosure can be manufactured in a compression molding process from a thermoformed plastic, although other materials providing adequate rigidity, durability, and dimensional stability may be suitable. Preferably, the material is electrically dissipative or conductive.

Additionally, the tray 10 can include a dissipative ESD mat 24 placed in the compartment 22 over the base 12. The ESD mat 24 prevents workpieces from sliding about the compartment 22. In addition, the ESD mat 24 helps reduce or prevent the accumulation of static electric energy by the workpieces and/or the tray 10.

The tray 10 can include four sidewalls 14, 16, 18, 20 around the perimeter of the base: a first sidewall 14, a second sidewall 16, a third sidewall 18 and a fourth sidewall 20. The sidewalls 14, 16, 18, 20 extend generally vertically upward and angle slightly outwardly from the base 12 of the tray 10 (i.e., the sidewalls 14, 16, 18, 20 taper outwardly relative to the base 12 at a draft angle). Each sidewall 14,16, 18, 20 can include a flange or lip 26 that is formed at the upper end of the sidewall 14, 16, 18, 20 and about the perimeter of the tray 10. The flange 26 extends outward of a central axis X of the tray 10 and generally parallel to the base 12. Preferably, the sidewalls 14, 16, 18, 20 and flanges 26 of the tray 10 are integrally formed with one another and the base 12 of the tray 10 to provide a continuous and uninterrupted one piece construction for the tray 10.

The height of the sidewalls 14, 16, 18, 20 determines the depth of the inner compartment 22 of the tray 10. The height of the sidewalls 14, 16, 18, 20 is preferably well-suited to support workpieces, such as electronic devices and components including printed circuit boards. The height of the sidewalls 14, 16, 18, 20 is generally about one inch or more.

One or more of the flanges 26 of the sidewalls 14,16, 18, 20 can include a dedicated handle or gripping portion 28 where a user can safely grip or grab the ESD tray 10 during manual handling of tray 10. The handles 28 can incorporate structure or material that can create or enhance a tactile response or visual cue to improve a user's (e.g., a technician or operator) ability to identify and/or safely grasp the tray 10.

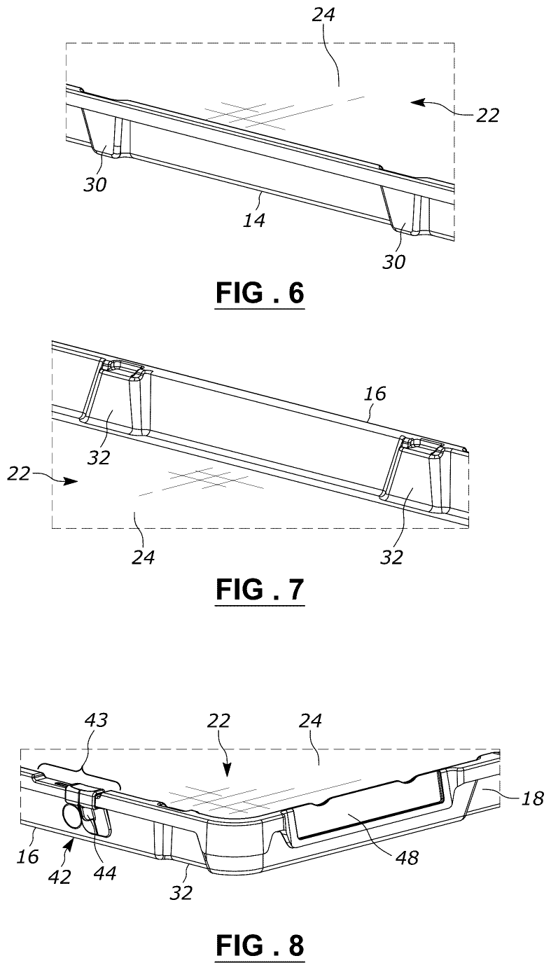

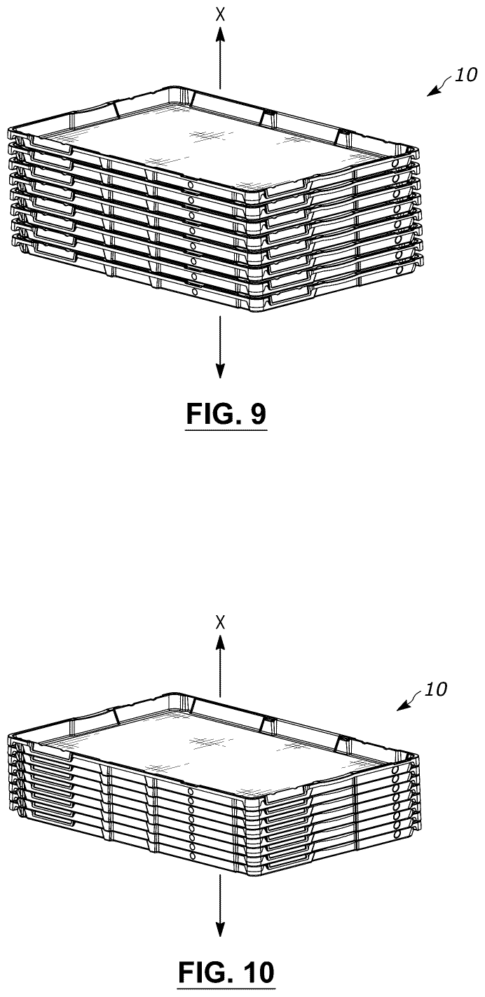

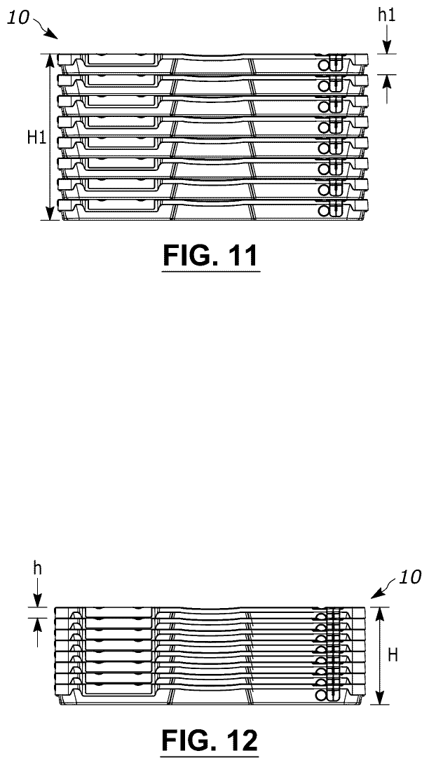

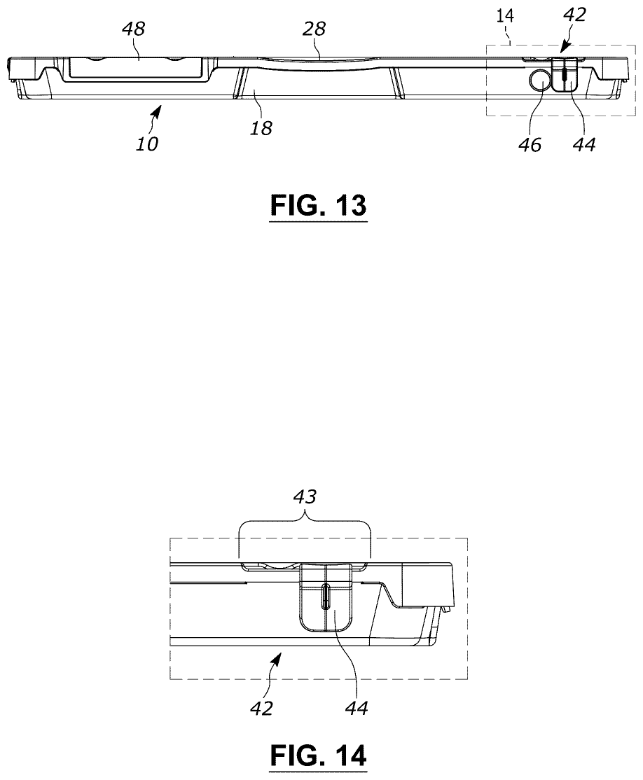

As best seen in FIGS. 1-13, the ESD tray 10 of the present disclosure provides means for both stacking and nesting the trays with one another. In particular, adjacent trays 10 can be configured to stack upon one another generally vertically as seen in FIGS. 9 and 11. When stacked, there is a clearance between the adjacent trays 10. That is, the inner compartment 22 of a lower tray 10 is not occupied by any portion (e.g., a base 12) of an upper tray 10 when in the stacked arrangement. The clearance allows the trays 10 to continue to house workpieces within the compartment 22 while stacked (e.g., at a workstation) with the base 12 of the upper tray 10 serving to cover and protect the workpieces located or stored in the compartment 22 of the lower tray 10.

Additionally, adjacent trays 10 can be nested with one another generally vertically as shown in FIGS. 10 and 12. When nested, the adjacent trays 10 are closely packed together such that a vertical height H of a plurality of trays is minimized. Consequently, there is no clearance or minimal clearance between the adjacent trays 10. In the nested arrangement, the compartment 22 of a lower tray 10 is not suited or is unable to contain workpieces because the base 12 and sidewalls 14, 16, 18, 20 of an upper tray 10 at least partially occupy the compartment 22 of the lower tray 10. The nested arrangement of ESD trays 10 of the present disclosure enables the efficient storage and transport of the ESD trays 10 when not in use. For example, when trays 10 are nested, the vertical space occupied by a given number of ESD trays 10 can be reduced by about 50% as compared to the same number of ESD trays 10 in a stacked arrangement.

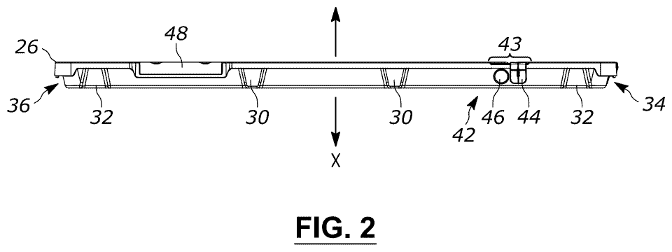

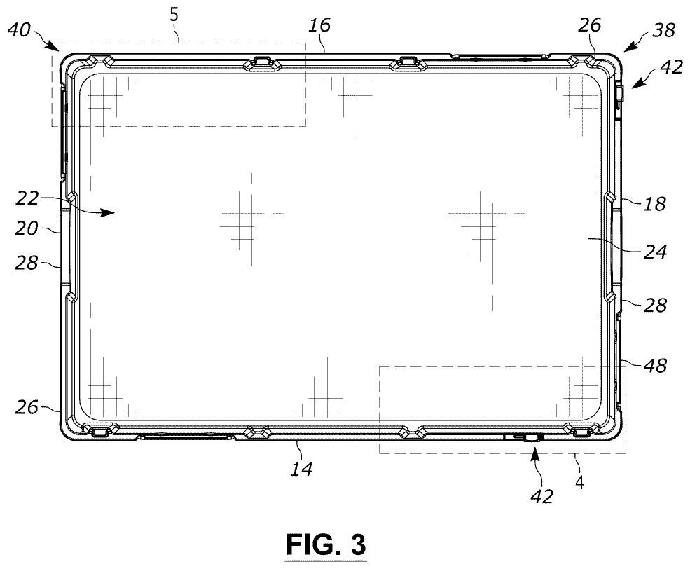

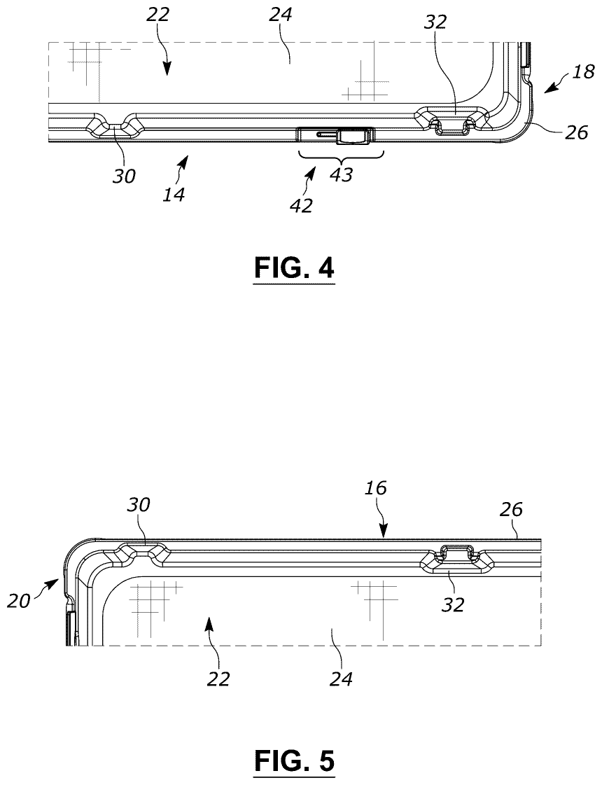

As seen in the FIGS. 2 and 3 and the detail FIGS. 4, 5, 6 and 7, each of the opposed first and second sidewalls 14, 16 of the tray 10 can incorporate one or more structural features including protrusions, ribs, bosses, projections, guides, grooves, recesses, slots or like structure 30, 32, that are spaced along a length of the sidewall 14,16. As best seen in FIGS. 2, 3, 4 and 6, a first sidewall 14 of the tray 10 can include two first structures or outward protrusions 30 that project outwardly from the compartment 22 and away from the central axis X and two second structures or inward protrusions 32 that project inwardly into the compartment 22 and toward the central axis X. The outward and inward protrusions 30, 32 can be spaced along the length of the first sidewall 14 (i.e., between the right and left sidewalls 18, 20). As seen in the figures the inward protrusions 32 are positioned at or near the opposite ends of the first sidewall 14 and the outward protrusions 30 are positioned intermediate the opposite ends of the first sidewall 14. As such, the order of the protrusions 30, 32 from a first end 34 of the first sidewall 14 to the opposite second end 36 of the first sidewall 14 is: inward protrusion 32—outward protrusion 30—outward protrusion 30—inward protrusion 32.

Further, as best seen in FIGS. 1, 3, 5 and 7, a second sidewall 16 of the tray 10 can also include two outward protrusions 30 and two inward protrusions 32. However, as seen in the figures, the outward protrusions 32 are positioned at or near the opposite ends of the second sidewall 16 and the inward protrusions 30 are positioned intermediate the opposite ends of the second sidewall 16. Thus, the order of the protrusions 30, 32 from a first end 38 of the second sidewall 16 to the opposite second end 40 of the second sidewall 16 is opposite to that of the first sidewall 14: outward protrusion 30—inward protrusion 32—inward protrusion 32—outward protrusion 30. The arrangement of the inward and outward protrusions 30, 32 on the first and second sidewalls 14, 16, therefore, is asymmetrical.

When two vertically adjacent trays 10 are in the same orientation (i.e., when the first sidewalls 14 and second sidewalls 16 of the trays 10, respectively, are vertically aligned—a first tray orientation), then the protrusions 30, 32 included in the first sidewall 14 and the protrusions 30, 32 included in the second sidewall 16 of vertically adjacent trays 10 also align with one another. As such, in the aligned, first orientation, the two trays 10 can nest together with the base 12 of the upper tray 10 being received in the compartment 22 of the lower tray 10 and the inward 32 and outward protrusions 30 of the first sidewall 14 and second sidewall 16 of the upper tray 10 likewise being received, respectively, in the inward and outward protrusions 30, 32 of the lower tray 10, as seen in FIGS. 10 and 12. Further, to assist with the nesting of adjacent trays 10, the inward and outward protrusions 30, 32 can be formed to include a taper or draft angle.

In a nested arrangement of a plurality of ESD trays 10 of the present disclosure, vertically adjacent trays 10 can be closely packed together with adjacent trays 10 spaced by a distance h, as best seen in FIG. 12. As such, a vertical height H of a plurality of trays 10 can be minimized to aid in the efficient storage and/or transport of the ESD trays 10 when the trays 10 are not in use.

However, when the first sidewalls 14 and second sidewalls 16 of the vertically adjacent trays 10 are opposed to one another (i.e., when one tray 10 is oriented 180 degrees relative to the other tray 10—a second tray orientation), then the respective inward protrusions 32 and outward protrusions 30 in the first sidewalls 14 and second sidewalls 16 of vertically adjacent trays 10 also oppose one another. In the opposed, second tray orientation, the diametric opposition or asymmetry of the respective inward and outward protrusions 30, 32 of the first sidewall 14 and second sidewall 16 prevent the vertically adjacent trays 10 from nesting, as previously described. Instead, the trays 10 are caused to stack upon one another as seen in FIGS. 9 and11. More specifically, when adjacent trays 10 are arranged vertically, the respective inward protrusions 32 of the upper tray 10 of the adjacent vertical trays 10 engage, rest upon and are supported by the respective outward protrusions 30 of the lower tray 10 of the adjacent vertical trays, and the respective outward protrusions 30 of the upper tray 10 of the adjacent vertical trays 10 engage, rest upon and are supported by the respective inward protrusions 32 of the lower tray 10 of the adjacent vertical trays 10.

In a stacked arrangement of a plurality of ESD trays 10 of the present disclosure, vertically adjacent trays 10 can be spaced apart by a distance h1, as best seen in FIG. 11, thereby providing for a clearance between the adjacent trays 10 such the inner compartment 22 of the lower tray is not occupied by the base 12 or sidewalls 14, 16, 18, 20 of an upper tray 10 and the lower tray 10 can contain workpieces within the compartment 22 while the trays 10 are stacked.

Referring to FIGS. 1, 2, 4, 8, 13 and 14, the ESD tray 10 of the present disclosure can further include a progress indicator 42 to support a manufacturing process workflow for electronic devices and components utilizing the trays 10.

The progress indicator 42 can provide visual indicia of the state of a workflow, process, task or the like relating to the contents of the ESD tray 10. For example, the progress indicator 42 can denote whether an operation has been completed or remains pending, and/or whether a device or component contained in the tray 10 is ready for a subsequent operation in a workflow, transport to another station, shipping or storage.

As the workpieces in a tray 10 process through a workflow, the progress indicator 42 can be manipulated by a technician or operator to signal a condition of the workpieces and/or tray 10. The progress indicator 42, therefore, provides a reliable, visual cue that enables the state or condition of workpieces and trays 10 to be easily identified and understood in order to promote efficient workflow and reduce uncertainty. A progress indicator 42 can be included at multiple locations on the ESD tray 10, such as on one or more sidewalls 14, 16, 18, 20 of the ESD tray 10.

As seen in the figures, a progress indicator 42 can incorporate a multi-position slider 44 and an associated marker 46. The slider 44 can be movably attached to the flange 26 or an edge of a sidewall 14, 16, 18, 20 of the tray 10. The slider 44 can move or slide along a selected or predetermined section or portion 43 of the sidewall 14,16, 18, 20 and between two or more positions on the sidewall 14, 16, 18, 20. One or more markers 46 can be associated with each slider 44. The markers 46 can be located on the of the outer surface sidewall 14, 16, 18, 20 in the predetermined portion 43. The slider 44 is operable to move over and past the one or more markers 46. That is, the markers 46 do not obstruct or impede the slider 44 from moving along the sidewall 14, 16, 18, 20. The slider 44 can be moved to cover or reveal the one or more markers 46. Thus, the position of the slider 44 relative to the marker 46 can provide a fast and easy visual indicator to communicate a current state of the tray 10 and/or the workpieces contained in the tray 10.

One or more locations on the ESD tray 10 of the present disclosure can provide a surface or marking region 48 to accommodate the placement of a label, such as a self-adhesive label, or to provide another surface able to accept writing, marking, coding or other indicia to identify and/or designate a condition or content of the ESD tray 10. As shown in the figures, a portion of the surface of each of the four sidewalls 14, 16, 18, 20 of the tray 10 can provide a marking region 48. Each marking region 48 can be a planar surface and inclined so as to face or be oriented upwardly. The particular dimensions and locations of the marking regions 48 can vary. However, it can be appreciated that the marking regions 48 can accept a label of a practice size, for example a ⅝ inch Dymo label.

Notably, when the ESD trays 10 are nested, the progress indicators 42 and the marking regions 48 do not impede or interfere with the ability of the trays 10 to nest with one another, as shown in FIGS. 10 and 12. Moreover, when the ESD trays 10 are stacked upon one another, the progress indicators 42 and the marking regions 48 are unobstructed and readily visible and able to convey information to an operator, as shown in FIGS. 9 and 11.

Turning to FIG. 15, one or more ESD trays 10 can be accommodated in a transport cart or rack 50. The transport cart 50 can safely transport the ESD trays 10 to and from a workstation, assembly area or manufacturing location. In addition, ESD safe transport carts 50 can provide additional electrical grounding for the ESD trays 10 and protect the ESD trays 10 and their contents from dirt, debris or other contamination. A known transport cart that can be suited for use with the ESD tray of the present disclosure is provided in U.S. Pat. No. 6,732,662, “Removable Tray and Tray Racking System,” which is assigned to the applicant of the present disclosure and incorporated by reference herein in its entirety.

The ESD tray 10 and transport cart 50 of the present disclosure incorporates features enabling multiple trays 10 to both nest with one another and stack upon one another. When not in use, empty trays 10 can be stored or transported in a compact and efficient arrangement requiring minimal space. When in use in a manufacturing environment (e.g., at a workstation or in a process queue) and while containing workpieces, the trays 10 can be vertically stacked on top of one another for easy and efficient access to a technician or operator. The ESD tray 10 further includes a progress indicator 42 and marking regions 48 that provide indicia of the tray and its contents to support an efficient workflow for the devices and components contained in the trays 10.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments have been provided so that this disclosure will be thorough and will fully convey the scope to those who are skilled in the art. Numerous specific details are set forth such as examples of specific components, devices, and methods, to provide a thorough understanding of embodiments of the present disclosure. Although the present disclosure has described the features and functions of a work tray in the context of an ESD tray, skilled persons will recognize that these same features and functions can be applied to any of a variety of trays for containing workpieces throughout a manufacturing process workflow for a variety of assembly, storage, staging and transport functions. Moreover, it will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

What is claimed is:

1. A work tray comprising:
a base;
a plurality of peripheral sidewalls extending upwardly from the base and about a perimeter of the base;
wherein the base and the sidewalls form an inner compartment of the tray;
wherein the sidewalls comprise a first sidewall and a second sidewall opposed to the first sidewall;
wherein the first sidewall comprises at least one first protrusion extending one of inwardly toward the compartment and outwardly away from the compartment;
wherein the second sidewall comprises at least one second protrusion extending the other one of inwardly toward the compartment an outwardly away from the compartment;
wherein the at least one first protrusion and the at least one second protrusion are diametrically opposed to one another.

2. The work tray of claim 1, wherein each of the first sidewall and second sidewall of the tray includes at least one first protrusion and at least one second protrusion; and
wherein each of the at least one first protrusion on the first sidewall opposes a respective one of the at least one second protrusion on the second sidewall; and
wherein each of the at least one second protrusion on the first sidewall opposes a respective one of the at least one first protrusion on the second sidewall.

3. The work tray of claim 1, wherein the first sidewall of the tray comprises two first protrusions that project outwardly from the compartment and away from a central axis of the tray; and
wherein the second sidewall of the tray comprises two second protrusions that project inwardly into the compartment and toward the central axis of the tray;
wherein each of the first protrusions on the first sidewall opposes a respective one of the second protrusions on the second sidewall.

4. The work tray of claim 1, wherein the first sidewall of the tray comprises a plurality of first protrusions that project outwardly from the compartment and away from a central axis of the tray and a plurality of second protrusions that project inwardly into the compartment and toward the central axis of the tray;
wherein the second sidewall of the tray comprises a plurality of second protrusions that project inwardly into the compartment and toward the central axis of the tray and a plurality of first protrusions that project outwardly from the compartment and away from a central axis of the tray;
wherein each of the first protrusions on the first sidewall opposes a respective one the second protrusions on the second sidewall and each of the second protrusions on the first sidewall opposes a respective one of the first protrusions on the second sidewall.

5. The work tray of claim 4, wherein the first and second protrusions on the first sidewall are spaced along a length of the first sidewall; and
wherein the first protrusions are positioned at or near opposite ends of the first sidewall and the second protrusions are positioned intermediate the opposite ends of the first sidewall.

6. The work tray of claim 5, wherein the second protrusions are positioned at or near opposite ends of the second sidewall and the first protrusions are positioned intermediate the opposite ends of the second sidewall.

7. The work tray of claim 6, wherein an arrangement of the first and second protrusions from a first end of the first sidewall to the opposite second end of the first sidewall is: second protrusion—first protrusion—first protrusion—second protrusion.

8. The work tray of claim 7, wherein an arrangement of the first and second protrusions from a first end of the second sidewall to the opposite second end of the second sidewall is: first protrusion—second protrusion—second protrusion—first protrusion.

9. The work tray of claim 4, wherein an arrangement of the first and second protrusions from a first end of the first sidewall to the opposite second end of the first sidewall is: second protrusion—first protrusion—first protrusion—second protrusion.

10. The work tray of claim 9, wherein an arrangement of the first and second protrusions from a first end of the second sidewall to the opposite second end of the second sidewall is: first protrusion—second protrusion—second protrusion—first protrusion.

11. The work tray of claim 4, wherein the arrangement of the respective second and first protrusions on the first and second sidewalls is asymmetrical.

12. The work tray of claim 1, wherein each of the first and second protrusions comprises a draft angle.

13. The work tray of claim 1, further comprising a progress indicator comprising a slide and a marker;
wherein the slide is slidably attached to a sidewall of the tray and the marker is fixedly located on the sidewall of the tray
wherein the slide is moveable past and over the marker such that the marker does not interfere with the slide; and
wherein the slide is moveable past and over the marker such that the slide is operable to cover and reveal the marker.

14. The work tray of claim 1, wherein at least one sidewall of the tray comprises a marking region including indicia of one of the status of the tray and the contents of the tray.

15. The work tray of claim 14, wherein the marking region comprises an inclined planar surface of the at least one sidewall of the tray that is oriented to face upwardly.

16. The work tray of claim 14, wherein the marking region comprises one of a self-adhesive label and a surface operable to accept indicia provided by a user; and
wherein the indicia comprises one of handwriting and a color code representing a condition or content of the tray.

17. The work tray of claim 1, wherein the sidewalls comprise a third sidewall and a fourth sidewall opposed to the right sidewall; and
wherein each of the third sidewall and the fourth sidewall includes a handle; and
wherein each handle incorporates a material providing one of a tactile response or a visual cue.

18. A work tray of claim 1, wherein the work tray is an ESD tray; and
wherein the ESD tray is formed from a material that resists the accumulation and discharge of static electricity.

19. A plurality of work trays according to claim 1 comprising at least a first work tray and a second work tray;
wherein, when the first work tray and the second work tray are positioned in a first orientation relative to one another, the first work tray is operable to nest within the second work tray; and
wherein, when the first work tray and the second work tray are positioned in a second orientation relative to one another, the first work tray is operable to stack on the second work tray.

20. The plurality of work trays according to claim 19, wherein in the first orientation the first sidewall of the first work tray is vertically aligned with the first sidewall of the second work tray and in the second orientation, the first sidewall of the first work tray is vertically aligned with the second sidewall of the second work tray.

21. The plurality of work trays according to claim 19, wherein, when the first work tray is stacked on the second work tray, the compartment of the second work tray is not occupied by any portion of the first work tray; and
wherein the second work tray is operable to house a workpiece within the compartment of the second work tray while the first work tray is stacked on the second work tray.

22. A transport cart for work trays comprising:
at least one work tray according to claim 1;
a chassis for removably supporting the at least one work tray, the chassis comprising at least two laterally spaced and vertically oriented racks, the racks each comprising spaced rungs in a mirror-image relationship; and
where at least two of the sidewalls of the at least one work tray engage the rungs;
wherein the rungs include a first plurality of rungs configured to support the at least one work tray and limit the vertical movement thereof;
wherein the at least one work tray slides on one set of the first plurality of rungs and tilts to engage with a second set of the first plurality of rungs; and
wherein the at least two racks comprise a second plurality of rungs configured to limit lateral movement of the at least one work tray.
